(19) United States
(12) Patent Application Publication
(10) Pub. No.: US 2025/0133252 A1
(43) Pub. Date: Apr. 24, 2025

(54) METHOD, APPARATUS, ELECTRONIC DEVICE AND STORAGE MEDIUM FOR RESOURCE INTERACTION

(71) Applicant: Beijing Youzhuju Network Technology Co., Ltd., Beijing (CN)

(72) Inventors: Lele HU, Beijing (CN); Jiali Hu, Beijing (CN)

(21) Appl. No.: 18/920,826

(22) Filed: Oct. 18, 2024

(30) Foreign Application Priority Data
Oct. 20, 2023 (CN) 202311370542.3

(51) Int. Cl. H04N 21/254; G06Q 30/0207; G06Q 30/0601; H04N 21/2187; H04N 21/478

(52) U.S. Cl. CPC H04N 21/2542; G06Q 30/0207; G06Q 30/0631; H04N 21/2187; H04N 21/47815

(57) ABSTRACT

The embodiment of the present disclosure provides a method and apparatus for resource interaction, an electronic device, and a storage medium. The method includes: presenting a recommended object interface in a live streaming interface of a current live streaming room, recommended object information of at least one recommended object in the current live streaming room and prompt information for a resource interaction object being presented within the recommended object interface, the resource interaction object being a recommended object added to a resource interaction object set, the resource interaction object set being a set of recommended objects selected by a current user in the current live streaming room, and the prompt information being configured to prompt object attribute information of the resource interaction object set; and in response to a resource interaction operation acting within the recommended object interface, performing resource interaction based on the resource interaction object.

### CROSS-REFERENCE

This disclosure claims priority to Chinese Patent Application No. 202311370542.3, filed on Oct. 20, 2023 and entitled “METHOD, APPARATUS, ELECTRONIC DEVICE AND STORAGE MEDIUM FOR RESOURCE INTERACTION”, which is incorporated herein by reference in its entirety.

### FIELD

The embodiment of the present disclosure relates to the technical field of computers, in particular to a method and an apparatus for resource interaction, electronic device and a storage medium.

### BACKGROUND

Currently, a user may select an item to be purchased and add the item to an item list, and select the added item from the item list for batch ordering. However, the function of the item list in the prior art is relatively single, and operations required for viewing attribute information of the selected item and obtaining the selected item are relatively complex.

### SUMMARY

The embodiment of the present disclosure provides a method and an apparatus for resource interaction, an electronic device, and a storage medium, so that the functions of the item list are enriched, and operations required for viewing attribute information of the selected item and obtaining the selected item are simplified.

According to a first aspect, an embodiment of the present disclosure provides a method for resource interaction, including:
presenting a recommended object interface in a live streaming interface of a current live streaming room, recommended object information of at least one recommended object in the current live streaming room and prompt information for resource interaction object being presented within the recommended object interface, the resource interaction object being a recommended object added to a resource interaction object set, the resource interaction object set being a set of recommended objects selected by a current user in the current live streaming room, and the prompt information being configured to prompt object attribute information of the resource interaction object set; and
in response to a resource interaction operation acting within the recommended object interface, performing resource interaction based on the resource interaction object.

According to a second aspect, an embodiment of the present disclosure further provides an apparatus for resource interaction, including:
a first interface display module, configured to present a recommended object interface in a live streaming interface of a current live streaming room, recommended object information of at least one recommended object in the current live streaming room and prompt information for resource interaction object being presented within the recommended object interface, the resource interaction object being a recommended object added to a resource interaction object set, the resource interaction object set being a set of recommended objects selected by a current user in the current live streaming room, and the prompt information being configured to prompt object attribute information of the resource interaction object set; and
a resource interaction module, configured to perform resource interaction based on the resource interaction object in response to a resource interaction operation acting within the recommended object interface.

According to a third aspect, an embodiment of the present disclosure further provides an electronic device. including:
one or more processors; and
a memory, configured to store one or more programs.
when executed by the one or more processors, the one or more programs cause the one or more processors to implement a method for resource interaction according to the embodiments of the present disclosure.

According to a fourth aspect, an embodiment of the present disclosure further provides a computer-readable storage medium storing a computer program thereon, the program, when executed by a processor, implements the resource interaction method according to the embodiment of the present disclosure.

The embodiments of the present disclosure provide a method and an apparatus for resource interaction, an electronic device and a storage medium, and the method includes: presenting a recommended object interface in a live streaming interface of a current live streaming room, recommended object information of at least one recommended object in the current live streaming room and prompt information for a resource interaction object being presented within the recommended object interface, the resource interaction object being a recommended object added to a resource interaction object set, the resource interaction object set being a set of recommended objects selected by a current user in the current live streaming room, and the prompt information being configured to prompt object attribute information of the resource interaction object set; and in response to a resource interaction operation acting within the recommended object interface, performing resource interaction based on the resource interaction object. According to the embodiment of the present disclosure, by adopting the above technical solution. the user is supported to view, in the recommended object interface, the object attribute information of the resource interaction object added to the resource interaction object set, and perform, in the recommended object interface. resource interaction on the resource interaction object added to the resource interaction object set by performing the resource interaction operation, so that functions of the recommended object interface can be enriched, and operations required for the user to view the attribute information of the resource interaction object and obtaining the resource interaction object in a resource interaction manner are simplified.

### BRIEF DESCRIPTION OF DRAWINGS

The above and other features, advantages, and aspects of embodiments of the present disclosure will become more apparent with reference to the following detailed description taken in conjunction with the accompanying drawings. Throughout the drawings, the same or similar reference numerals denote the same or similar elements. It shall be understood that the drawings are schematic and that components and elements are not necessarily drawn to scale.

FIG. 1 is a schematic flowchart illustrating a method for resource interaction according to an embodiment of the present disclosure;

FIG. 2 is a schematic diagram presenting a recommended object interface according to an embodiment of the present disclosure;

FIG. 3 is a schematic diagram presenting a live streaming interface according to an embodiment of the present disclosure;

FIG. 4 is a schematic diagram presenting an information confirmation interface according to an embodiment of the present disclosure;

FIG. 5 is a schematic diagram presenting a target object interface according to an embodiment of the present disclosure;

FIG. 6 is a schematic flowchart illustrating another method for resource interaction according to an embodiment of the present disclosure;

FIG. 7 is a schematic diagram presenting a resource interaction object set according to an embodiment of the present disclosure;

FIG. 8 is a schematic diagram presenting prompt information according to an embodiment of the present disclosure;

FIG. 9 is a structural block diagram of an apparatus for resource interaction according to an embodiment of the present disclosure;

FIG. 10 is a schematic structural diagram of an electronic device according to an embodiment of the present disclosure.

### DETAILED DESCRIPTION

Embodiments of the present disclosure will be described below with reference to the accompanying drawings. While certain embodiments of the present disclosure are shown in the drawings, it shall be understood that the present disclosure may be implemented in various forms, and should not be construed as limited to the embodiments set forth herein. On the contrary; these embodiments are provided for a more thorough and complete understanding of the present disclosure. It shall be understood that the drawings and embodiments of the present disclosure are provided for illustrative purposes only and are not intended to limit the scope of protection of the present disclosure.

It shall be understood that the various steps described in the method implementation of this disclosure can be executed in different orders and/or in parallel. In addition, the method implementation can include additional steps and/or the steps as shown may be omitted. The scope of this disclosure is not limited in this regard.

The term “including” and its variations as used herein are non-exclusive inclusion, i.e. “including but not limited to”. The term “based on” means “at least partially based on”. The term “one embodiment” indicates “at least one embodiment”; the term “another embodiment” indicates “at least one additional embodiment”; and the term “some embodiments” indicates “at least some embodiments”. Relevant definitions of other terms will be given in the following description.

It should be noted that the concepts of “first” and “second” mentioned in this disclosure are only used to distinguish different devices, modules, or units, but are not used to limit the order or interdependence of the functions performed by these devices, modules, or units.

It should be noted that the modifications of “one (a)” and “a plurality of” mentioned in this disclosure are illustrative but not limiting. Those skilled in the art should understand that unless otherwise indicated in the context. they should be understood as “one or more”.

The names of messages or information interaction between multiple devices in embodiments of the present disclosure are described for illustrative purposes only and are not intended to limit the scope of such messages or information.

It may be understood that, before the technical solutions disclosed in the embodiments of the present disclosure are used, the user should be notified of the type, use range, use scenario, etc, of the personal information involved in the present disclosure and authorized by the user in an appropriate manner according to related laws and regulations.

For example, in response to receiving an active request from a user, a prompt message is sent to the user to explicitly prompt the user that the operation requested to be performed will require acquiring and using personal information of the user. Thus, the user can autonomously select whether to provide personal information to software or hardware such as electronic devices, applications, servers, or storage media that perform operations of the disclosed technical solution, based on the prompt message.

As an optional but non-limiting implementation, in response to receiving an active request from the user. prompt information is sent to the user, for example, in the form of a pop-up window, and the pop-up window may present the prompt information in the form of text. In addition, the pop-up window may also carry a selection control for the user to select whether he/she “agrees” or “disagrees” to provide personal information to the electronic device.

It can be understood that the above notification and user authorization process are only illustrative which do not limit the implementation of this disclosure. Other methods that meet relevant laws and regulations can also be applied to the implementation of this disclosure.

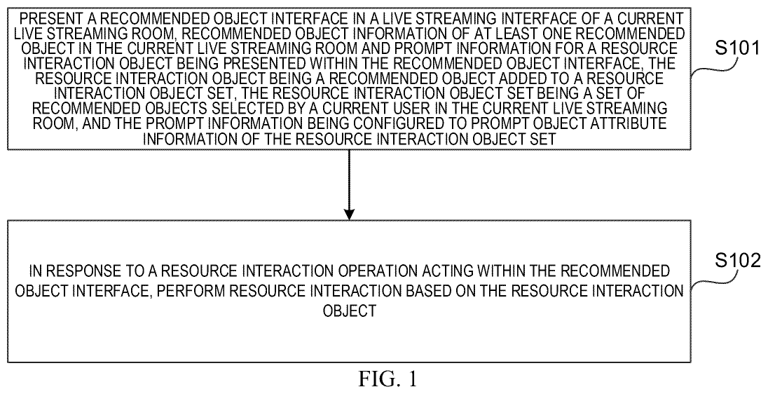

FIG. 1 is a schematic flowchart illustrating a method for resource interaction according to an embodiment of the present disclosure. The method may be performed by an apparatus for resource interaction, and the apparatus may be implemented by software and/or hardware, may be configured in an electronic device, and typically, may be configured in a mobile phone or a tablet computer. The method for resource interaction provided by the embodiment of the present disclosure is applicable to a scene of performing resource interaction on a recommended object added to an object set, and particularly applicable to a scene of viewing attribute information of the recommended object added to the object set and performing resource interaction on the recommended object added to the object set. As shown in FIG. 1, the method for resource interaction provided in this embodiment may include the following steps.

At S101, a recommended object interface is presented in a live streaming interface of a current live streaming room, where recommended object information of at least one recommended object in the current live streaming room and prompt information for a resource interaction object are presented in the recommended object interface, the resource interaction object is a recommended object added to a resource interaction object set, the resource interaction object set is a set of recommended objects selected by a current user in the current live streaming room, and the prompt information is configured to prompt object attribute information of the resource interaction object set.

The current live streaming room may be a live streaming room watched by a current user, and the current user may be a user currently watching live streaming, for example, an audience currently watching live streaming. The live streaming interface of the current live streaming room may be an interface for presenting a live streaming video stream of the current live streaming room, for example, a live streaming page of the current live streaming room.

The recommended object interface may be an interface for presenting recommended object information of the recommended object in the current live streaming room, for example, an interface for presenting a list of recommended objects of the current live streaming room. There is no limitation on the way of presenting the recommended object interface in the live streaming interface, for example, the recommended object interface may be presented in a form of a window, a panel, or a half-screen page, the following description will be provided by taking the recommended object interface being presented in the form of the panel as an example.

The recommended object may be an object recommended in the current live streaming room, for example, an item recommended by an anchor of the current live streaming room to users in the current live streaming room. The recommended object information may be considered as information of the recommended object, such as a picture, a name, and/or a corresponding resource value of the recommended object. The resource value may be used to represent a value of the recommended object, and in some implementations, the resource value corresponding to the recommended object may be a price of the recommended object.

The resource interaction object set may be a set of recommended objects selected by the current user in the current live streaming room, for example, the current user may select a recommended object in a recommended object interface of the current live streaming room and add the selected recommended object to the resource interaction object set. The resource interaction object is a recommended object added in the resource interaction object set. Exemplarily, when there is only one corresponding store in the current live streaming room, the recommended object interface may be used to present recommended object information of a recommended object in the store, and the resource interaction object set may be a set of recommended objects in the store and selected by the current user in the current live streaming room. When there are multiple corresponding stores in the current live streaming room, the recommended object interface may be configured to present recommended object information of recommended objects in the multiple stores, and the resource interaction object set may be a set of recommended objects in the multiple stores and selected by the current user in the current live streaming room; or the recommended object interface may be configured to present recommended object information of recommended objects in a store. and the resource interaction object set may be a set of recommended objects in the store and selected by the current user in the current live streaming room.

The recommended object interface may further be presented with prompt information for the resource interaction object, and the prompt information may be used to prompt object attribute information of the resource interaction object set. The object attribute information may be used to describe an attribute of a resource interaction object added in the resource interaction object set. Optionally, the object attribute information includes resource attribute information and/or quantity attribute information; and the resource attribute information includes a total resource value of the resource interaction objects, and/or first difference information between a first resource threshold of a first resource interaction condition and the total resource value, or second difference information between a second resource threshold of a second resource interaction condition and the total resource value, where the first resource interaction condition is that the total resource value of the resource interaction objects is greater than or equal to the first resource threshold, the second resource interaction condition is that the total resource value of the resource interaction objects is greater than or equal to the second resource threshold, and the second resource threshold is greater than the first resource threshold.

The first resource interaction condition and the second resource interaction condition may be different resource interaction conditions predetermined in the current live streaming room. The first resource interaction condition may be that the total resource value of the resource interaction objects is greater than or equal to the first resource threshold. the second resource interaction condition may be that the total resource value of the resource interaction objects is greater than or equal to the second resource threshold, and the second resource threshold is greater than the first resource threshold. The first difference information may be difference information between the first resource threshold and the total resource value of the resource interaction objects, and the second difference information may be difference information between the second resource threshold and the total resource value of the resource interaction objects. For example, the first resource interaction condition may include a delivery starting condition. and the second resource interaction condition may include a delivery fee free condition and/or a reduction condition.

The resource attribute information may be used to describe a resource attribute of resource interaction objects added in the resource interaction object set, for example, a total resource value of the resource interaction objects added in the resource interaction object set, and/or first difference information or second difference information. The quantity attribute information may be used to describe a quantity attribute of the resource interaction objects added in the resource interaction object set, for example, a total quantity of the resource interaction objects added in the resource interaction object set.

The presentation position of the prompting information for the resource interaction object in the recommended object interface can be flexibly set as needed. Optionally, the prompt information is presented above the recommended object information, that is, the prompt information for the resource interaction object may be presented above the recommended object information presented on the recommended object interface. In other words, an area of the recommended object interface where the prompting information is presented may be located above an area of the recommended object interface where the recommended object information is presented.

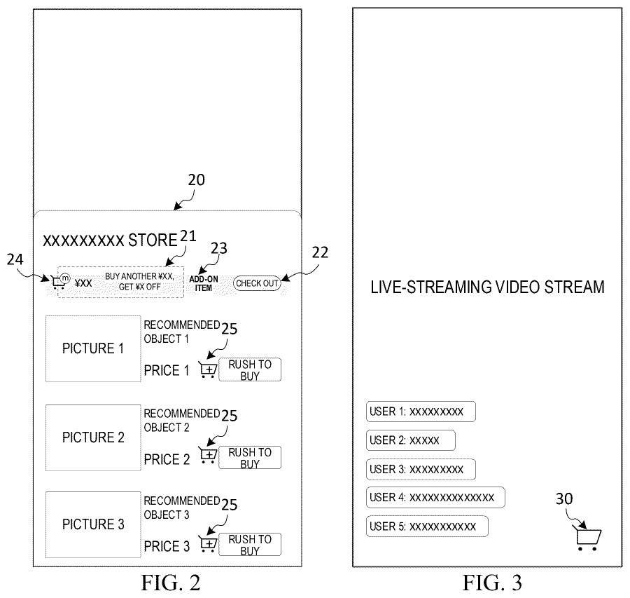

In this embodiment, when the current user is watching the recommended object information of the current live streaming room, the recommended object interface 20 of the current live streaming room may be presented in the live streaming interface of the current live streaming room, the recommended object information of at least one recommended object in the current live streaming room and the prompt information 21 for the resource interaction object are presented in the recommended object interface 20, and the object attribute information of the resource interaction object in the resource interaction object set may be prompted through the prompt information 21, as shown in FIG. 2, for the current user to view and interact with.

In this embodiment, the presenting condition for the recommended object interface may be set as needed, for example, when a preset condition is met, the current application program may automatically present the recommended object interface of the current live streaming room in the live streaming interface of the current live streaming room, without needing the current user to execute a corresponding triggering operation for instructing to present the recommended object interface of the current live streaming room; or the recommended object interface of the current live streaming room may be presented in the live streaming interface of the current live streaming room when receiving from the current user a corresponding trigger operation for instructing to present the recommended object interface of the current live streaming room.

In some implementations, the recommended object interface of the current live streaming room may be presented in the live streaming interface of the current live streaming room based on a corresponding triggering operation from the current user, so that when the user views the recommended object interface, interference on the user's viewing of the live video stream is avoided. In this case, optionally, presenting the recommended object interface in the live streaming interface of the current live streaming room includes: presenting a live streaming video stream of the current live streaming room in the live streaming interface of the current live streaming room; and presenting the recommended object interface in the live streaming interface in response to a recommended object presenting operation acting within the live streaming interface.

The live streaming video stream may be video stream for live streaming performed by an anchor of the current live streaming room. The recommended object presenting operation may be a triggering operation for instructing to present the recommended object interface of the current live streaming room. For example, the manner for performing the recommended object presenting operation may not be limited, for example, the recommended object presenting operation may be a gesture operation acting within the live streaming interface, for example, a gesture operation of sliding along a set direction or a set path in the live streaming interface; or may be an operation of triggering a recommended object control presented in the live streaming interface.

Specifically, when the live streaming interface of the current live streaming room is displayed, a live streaming video stream of the current live streaming room may be presented in the live streaming interface of the current live streaming room, as shown in FIG. 3; when a recommended object presenting operation is received from a current user, for example, when it is detected that the current user triggers a recommended object control 30 presented in the live streaming interface, a recommended object interface 20 may be presented in the live streaming interface, and recommended object information of at least one recommended object in the current live streaming room and prompt information 21 for a resource interaction object are presented in the recommended object interface 20, as shown in FIG. 2.

At S102, resource interaction is performed based on the resource interaction object in response to a resource interaction operation acting within the recommended object interface.

The resource interaction operation may be a triggering operation for instructing to perform resource interaction based on a resource interaction object in the resource interaction object set, for example, the resource interaction operation may be used to indicate that a resource interaction object has been selected and/or a resource interaction process is entered. The manner for performing the resource interaction operation is not limited, and it may be acted to the recommended object interface. Exemplarily, the resource interaction operation may be an operation that triggers the resource interaction control within the recommended object interface.

Specifically, when a resource interaction operation of the current user within the recommended object interface is received, such as when it is detected that the current user triggers the resource interaction control 22 within the recommended object interface (as shown in FIG. 2), a recommended object in a resource interaction object set of the current user may be taken as the resource interaction object at this time, such as taking respective recommended objects contained in the resource interaction object set of the current user as the resource interaction objects at this time, and the resource interaction is performed based on the determined resource interaction objects, so as to issue. mail or deliver the resource interaction object in the resource interaction object set to the current user after the resource interaction is completed.

In this embodiment, a user is supported to view object attribute information of a resource interaction object added to a resource interaction object set in a recommended object interface, and perform, in the recommended object interface, resource interaction on the resource interaction object added to the resource interaction object set by performing a resource interaction operation, so that functions of the recommended object interface can be enriched. and operations required for the user to view the attribute information of the resource interaction object and obtain the resource interaction object in a resource interaction manner are simplified.

In this embodiment, after the resource interaction object is determined, resource interaction may be performed based on the determined resource interaction object; or after the resource interaction object is determined and an interaction confirmation operation is received from the user, resource interaction may be performed based on the determined resource interaction object. For example, resource interaction is performed based on a total resource value corresponding to the resource interaction objects, and in this case, optionally, performing the resource interaction based on the resource interaction object in response to a resource interaction operation acting within the recommended object interface includes: in response to a resource interaction operation acting within the recommended object interface, presenting an information confirmation interface in the live streaming interface, and presenting resource interaction information of the resource interaction object in the information confirmation interface; in response to an information confirmation operation acting within the information confirmation interface. displaying a resource interaction interface; and in response to an interaction confirmation operation acting within the resource interaction interface, performing resource interaction based on a total resource value of the resource interaction objects.

The information confirmation interface may be an interface for the user to confirm the related information for performing the current resource interaction, and it may be presented in a form of a window, a panel, or a half-screen page. Resource interaction information for the current resource interaction may be presented in the information confirmation interface, and the related information may include, for example, current resource interaction object information, receipt information, and/or delivery information. The resource interaction object information may be information about resource interaction objects, for example, identification information, quantity information, and/or a corresponding total resource value of the resource interaction objects. The information confirmation operation may be a triggering operation used to indicate that confirmation of related information of the current resource interaction is completed, and the manner of performing the information confirmation operation is not limited. Optionally, the information confirmation operation may be an operation of triggering an information confirmation control in the information confirmation interface.

The resource interaction interface may be an interface for resource interaction, and it may be presented in a form of a window, a panel, a half-screen page, or the like. The resource interaction interface may be presented with related information of the current resource interaction, for example, an account for performing the current resource interaction and a total resource value for performing the current resource interaction. The resource interaction interface may be used by the current user to trigger execution of the interaction confirmation operation, for example. an interaction confirmation control for the current user to trigger execution of the interaction confirmation operation may be presented in the resource interaction interface. The interaction confirmation operation may be a triggering operation for indicating confirmation to perform resource interaction.

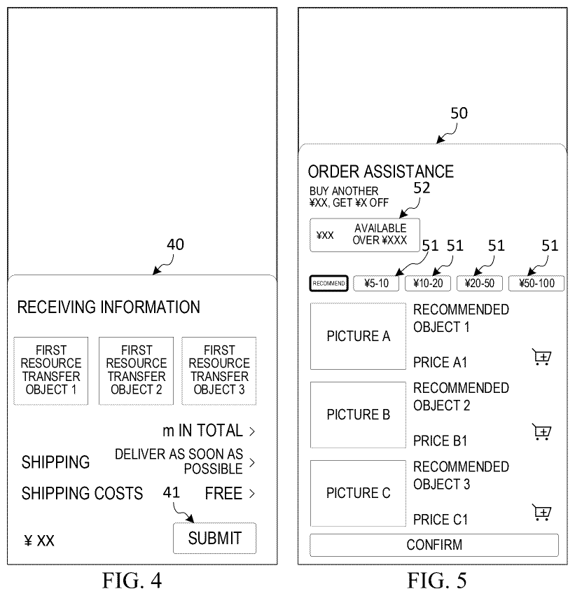

Exemplarily, after the resource interaction object is determined, the information confirmation interface 40 may be displayed in the live streaming interface, and the resource interaction object information of the resource interaction object is presented in the information confirmation interface 40, as shown in FIG. 4; when receiving an information confirmation operation of the current user in the information confirmation interface 40, for example, when it is detected that the current user triggers the information confirmation control 41 in the information confirmation interface, the resource interaction interface may be displayed in the live streaming interface; and when receiving an interaction confirmation operation of the current user in the resource interaction interface, resource interaction may be performed based on the resource interaction object in response to the interaction confirmation operation.

In some implementations, when the total resource value of the resource interaction objects does not meet the first resource interaction condition or the second resource interaction condition, an object presentation control is further presented within a preset distance range of the prompt information, and the method for resource interaction provided in this embodiment further includes: in response to a triggering operation on the object presentation control. presenting a target object interface in the live streaming interface, recommended object information of at least one target recommended object in the current live streaming room is presented in the target object interface, wherein the target recommended object is determined based on first difference information between a first resource threshold of the first resource interaction condition and the total resource value, or the target recommended object is determined based on second difference information between a second resource threshold of the second resource interaction condition and the total resource value.

In this embodiment, when the total resource value of the resource interaction object does not meet the first resource interaction condition or the second resource interaction condition, the object display control may be further presented in the recommended object interface, so that the user can quickly add recommended objects to meet the first resource interaction condition or the second resource interaction condition. For example, when a resource interaction object has been added to the resource interaction object set and the total resource value of the resource interaction objects does not meet the first resource interaction condition, an object presentation control corresponding to the first resource interaction condition may be presented; and when the total resource value of the resource interaction objects in the resource interaction set meets the first resource interaction condition but does not meet the second resource interaction condition, an object presentation control corresponding to the second resource interaction condition may be presented.

The object presentation control may be a control for triggering presentation of recommended object information of recommended objects in the current live streaming room and corresponding to a resource interaction condition (for example, the first resource interaction condition or the second resource interaction condition) that corresponds to the object presentation control. The object presentation control may be presented at an associated position of the prompt information, for example, presented within a preset distance range of the prompt information. and the preset distance range is not limited in this embodiment.

The target recommended object may be a recommended object corresponding to the first resource interaction condition or the second resource interaction condition. For example, when the object presentation control corresponding to the first resource interaction condition is presented in the recommended object interface, the target recommended object may be recommended object added by the current user to the resource interaction object set so that the total resource value of the resource interaction objects meets the first resource interaction condition, and it may be determined based on the first difference information; or when the object presentation control corresponding to the second resource interaction condition is presented in the recommended object interface, the target recommended object may be a recommended object added by the current user to the resource interaction object set so that the total resource value of the resource interaction objects meets the second resource interaction condition. and it may be determined based on the second difference information.

Exemplarily, when it is detected that the current user triggers the object presentation control 23 (as shown in FIG. 3) presented in the recommended object interface, a target recommended object corresponding to the first resource interaction condition or the second resource interaction condition that has not been met by the resource interaction objects may be determined, and recommended object information of the target recommended object is presented, for example, the target object interface 50 is presented in the live streaming interface, and the recommended object information of the target recommended object is presented in the target object interface 50, as shown in FIG. 5. Therefore, the current user may select a target recommended object from the target object interface 50 and add the target recommended object to the resource interaction object set, to increase a total resource value of resource interaction objects included in the resource interaction object set, so that the total resource meets the first resource interaction condition or the second resource interaction condition that has not been met currently.

In addition, as shown in FIG. 5, the target object interface 50 may further be presented with at least one resource value area 51 and/or promotional information 52, and the promotional information 52 may correspond to the first resource interaction condition and/or the second resource interaction condition. For example, the promotional information 52 and the object presentation control may correspond to a same resource interaction condition (for example, the first resource interaction condition or the second resource interaction condition).

In this case, optionally, at least one of at least one resource value range, promotional information of the first resource interaction condition, and promotional information of the second resource interaction condition is further presented in the target object interface, and the resource value range is configured to trigger presentation of a target recommended object corresponding to a triggered resource value range in the target object interface.

The embodiments of the present disclosure provide a method for resource interaction, including: presenting a recommended object interface in a live streaming interface of a current live streaming room, recommended object information of at least one recommended object in the current live streaming room and prompt information for a resource interaction object being presented within the recommended object interface, the resource interaction object being a recommended object added to a resource interaction object set, the resource interaction object set being a set of recommended objects selected by a current user in the current live streaming room, and the prompt information being configured to prompt object attribute information of the resource interaction object set; and in response to a resource interaction operation acting within the recommended object interface, performing resource interaction based on the resource interaction object. According to the embodiment of the present disclosure, by adopting the above technical solution, the user is supported to view, in the recommended object interface, the object attribute information of the resource interaction object added to the resource interaction object set, and perform, in the recommended object interface, resource interaction on the resource interaction object added to the resource interaction object set by performing the resource interaction operation, so that functions of the recommended object interface can be enriched, and operations required for the user to view the attribute information of the resource interaction object and obtaining the resource interaction object in a resource interaction manner are simplified.

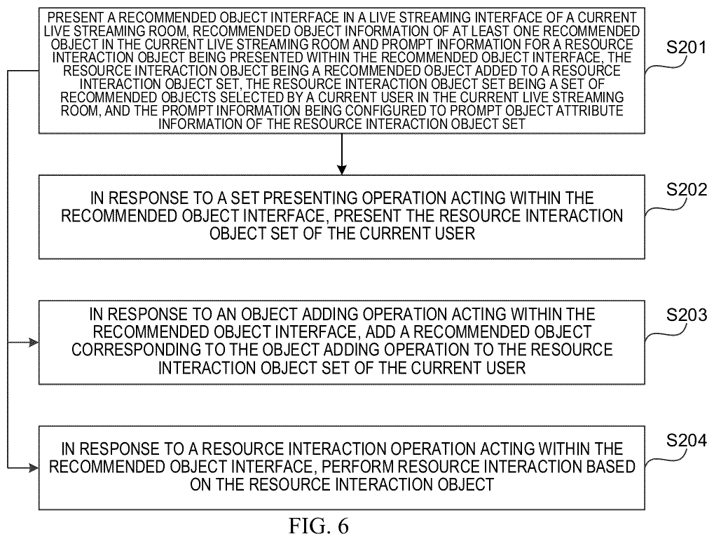

FIG. 6 is a schematic flowchart illustrating another method for resource interaction according to an embodiment of the present disclosure. The solution in this embodiment may be combined with one or more optional solutions in the foregoing embodiments. Optionally, the method further includes at least one of the following: after presenting the recommended object interface in the live streaming interface of the current live streaming room, in response to a set presenting operation acting within the recommended object interface, presenting the resource interaction object set of the current user; and in response to an object adding operation acting within the recommended object interface, adding a recommended object corresponding to the object adding operation to the resource interaction object set of the current user.

Correspondingly, as shown in FIG. 6, the method for resource interaction provided in this embodiment may include the following steps.

At S201, a recommended object interface is presented in a live streaming interface of a current live streaming room, and at least one of S202-S204 is performed, where recommended object information of at least one recommended object in the current live streaming room and prompt information for a resource interaction object are presented in the recommended object interface, the resource interaction object is a recommended object added to a resource interaction object set, the resource interaction object set is a set of recommended objects selected by a current user in the current live streaming room, and the prompt information is configured to prompt object attribute information of the resource interaction object set.

At S202, in response to a set presenting operation acting within the recommended object interface, the resource interaction object set of the current user is presented.

The set presenting operation may be a triggering operation for instructing to present the resource interaction object set of the current user, for example, an operation of triggering a set control for the resource interaction object set and presented in the recommended object interface.

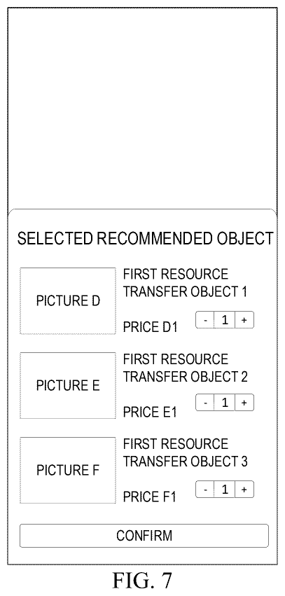

Exemplarily, when a set presenting operation of the current user is received, for example, when it is detected that the current user triggers the set control 24 presented in the recommended object interface (as shown in FIG. 2). the resource interaction object set of the current user may be presented, for example, a presentation interface for the resource interaction object set is presented in the live streaming interface, and the resource interaction object set is presented in the presentation interface, as shown in FIG. 7.

In this embodiment, after the resource interaction object set is presented, a user may be supported to adjust resource interaction objects included in the resource interaction object set, for example, increase or decrease the quantity of resource interaction objects and/or delete a resource interaction object included in the resource interaction object set.

At S202, in response to an object adding operation acting within the recommended object interface, a recommended object corresponding to the object adding operation is added to the resource interaction object set of the current user.

The object adding operation may be a triggering operation configured to instruct to add a recommended object in the current live streaming room, as a resource interaction object, to the resource interaction object set of the current user. The manner for executing the object adding operation is not limited herein. For example, the object adding operation may be an operation of triggering an addition control corresponding to a certain recommended object or an operation of triggering an addition option for a recommended object.

Specifically, when an object adding operation of the current user on the recommended object interface is received, the recommended object corresponding to the object adding operation may be added to the resource interaction object set of the current user.

Exemplarily, when the recommended object interface 20 is presented, the recommended object information of at least one recommended object in the current live streaming room and the addition control 25 corresponding to the recommended object may be presented in the recommended object interface 20, as shown in FIG. 2. When it is detected that the current user triggers an addition control 25 corresponding to a recommended object, it may be determined that an object adding operation for the recommended object is received, and the recommended object is added to the resource interaction object set of the current user in response to the recommended object operation.

It may be understood that when it is detected that a current user triggers an addition control corresponding to a certain recommended object, if there are a plurality of addition options for the recommended object, the plurality of addition options may be further presented in the object addition interface, and when it is detected that a current user triggers a certain addition option, the recommended object is added to the recommendation set of the current user based on the addition option triggered by the current user. Different addition options may correspond to different addition attribute information of the recommended object, for example, different addition options may correspond to different models or addition quantities of the recommended objects.

In some implementations, the recommended object information includes an image element of the recommended object, and the method for resource interaction provided in this embodiment may further include: in response to an object adding operation, controlling an image element of a recommended object corresponding to the object adding operation to move to a preset display position of the recommended object interface, the object adding operation acting within the recommended object interface or an object addition interface, at least one adding option for the recommended object corresponding to the object adding operation is presented in the object addition interface. and the preset display position is a display position for a set control of the resource interaction object set; and in response to that the image element moves to the preset display position, canceling presentation of the image element. and additionally presenting the quantity attribute information of the resource interaction object or updating the quantity attribute information of the resource interaction object.

The preset display position may be a display position of the set control for the resource interaction object set in the recommended object interface.

In this embodiment, when the object adding operation is received, the image element of the recommended object corresponding to the object adding operation may also be controlled to move to the preset display position of the recommended object interface in response to the object adding operation, for example, the image element is controlled to move to the display position of the set control for the resource interaction object set; and after the image element moves to the preset display position, the presentation of the image element is canceled, and the quantity attribute information of the resource interaction objects is additionally presented or the quantity attribute information of the resource interaction objects is updated, so as to present a visual effect of adding the recommended object corresponding to the object adding operation to the resource interaction object set.

Exemplarily, for a recommended object with only one addition option, when it is detected that the current user triggers the addition control for the recommended object in the recommended object interface, it may be determined that an object adding operation for the recommended object is received, and in response to the object adding operation. the image element of the recommended object is controlled to move to the preset display position of the recommended object interface. In response to that the image element moves to the preset display position. presentation of the image element is cancelled; and when the quantity attribute information of the resource interaction objects is not presented in the recommended object interface, the quantity attribute information of the resource interaction objects is additionally presented in the recommended object interface, and when the quantity attribute information of the resource interaction objects is presented in the recommended object interface, the quantity attribute information presented in the recommended object interface is updated.

For a recommended object with a plurality of addition options, when it is detected that a current user triggers an addition control for a recommended object in the recommended object interface, an object addition interface foe the recommended object may be presented, and at least one addition option for the recommended object is presented in the object addition interface. When it is detected that the current user triggers a certain addition option displayed in the object addition interface, it may be determined that the object adding operation for the recommended object is received, and in response to the recommended object operation, the presentation of the object addition interface is canceled, and the image element of the recommended object is controlled to move to the preset display position of the recommended object interface. In response to that the image element moves to the preset display position. presentation of the image element is cancelled; and when the quantity attribute information of the resource interaction object is not presented in the recommended object interface, the quantity attribute information of the resource interaction object is additionally presented in the recommended object interface, and when the quantity attribute information of the resource interaction object is presented in the recommended object interface, the quantity attribute information presented in the recommended object interface is updated.

In this embodiment, the information content of the prompt information for the resource interaction object may include object attribute information of the resource interaction object, to prompt the resource attribute information of the resource interaction object. When the resource attribute information of the resource interaction object changes. for example, after the recommended object corresponding to the object adding operation is added to the resource interaction object set of the current user, information content of the prompt information presented in the recommended object interface may be updated based on the added recommended object. In this case, optionally, after adding the recommended object corresponding to the object adding operation to the resource interaction object set of the current user, the method further includes: updating information content of the prompt information, the information content comprising the object attribute information, and the object attribute information comprising resource attribute information and/or quantity attribute information; and the resource attribute information comprising a total resource value of the resource interaction objects, and/or first difference information between a first resource threshold for a first resource interaction condition and the total resource value, or second difference information between a second resource threshold for a second resource interaction condition and the total resource value, wherein the first resource interaction condition is that the total resource value of the resource interaction objects is greater than or equal to the first resource threshold, the second resource interaction condition is that the total resource value of the resource interaction object is greater than or equal to the second resource threshold, and the second resource threshold is greater than the first resource threshold.

In some implementations, updating the information content of the prompt information includes: in response to that no resource interaction object has been added to the resource interaction object set, presenting the quantity attribute information of the resource interaction object and the second resource interaction condition; in response to that a resource interaction object is added to the resource interaction object set and a total resource value of the resource interaction objects has not reached the first resource threshold, presenting the quantity attribute information and the total resource value of the resource interaction objects, and the first difference value information; in response to that the total resource value of the resource interaction object has reached the first resource threshold and has not reached the second resource threshold, presenting the quantity attribute information and the total resource value of the resource interaction objects, and switching the first difference value information to the second difference value information; and in response to that the total resource value of the resource interaction objects has reached the second resource threshold, canceling presentation of the prompt information, or presenting promotional information of the first resource interaction condition and/or promotional information of the second resource interaction condition.

In the foregoing implementation, when the resource interaction object set is in a different state or when the total resource value of the resource interaction objects in the resource interaction object set meets different resource interaction conditions (for example, the first resource interaction condition or the second resource interaction condition), the information content of the prompt information presented may not be completely the same.

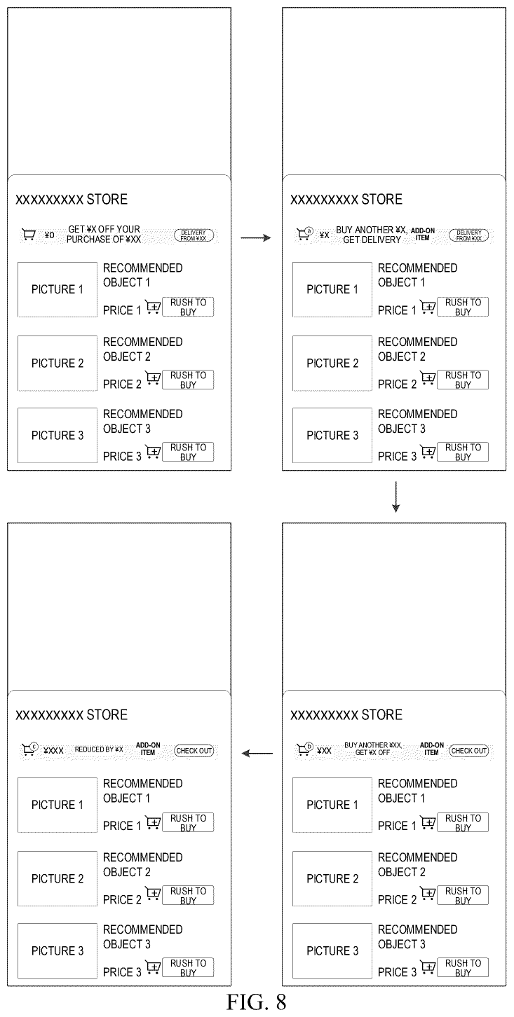

For example, a manner of presenting the information content of the prompt information may be described as follows: when the resource interaction object set is empty, that is, when the current user has not added any recommended object to the resource interaction object set, a total resource value (in this case, the total resource value is 0) corresponding to the resource interaction objects in the resource interaction object set and a second resource interaction condition for the current live streaming room may be presented, as shown in the first figure in FIG. 8 (in the drawing, the second resource interaction condition is a reduction condition).

In this case, after the current user adds a recommended object, as a resource interaction object, to the resource interaction object set, the quantity attribute information of the resource interaction objects included in the resource interaction object set may be additionally presented at the first preset position of the recommended object interface. and the total resource value presented in the recommended object interface is updated.

When the resource interaction object is added to the resource interaction object set and the total resource value of the resource interaction objects has not reached the first resource threshold of the first resource interaction condition, the quantity attribute information, the total resource value, and the first difference value information of the resource interaction object may be presented, as shown in the second figure in FIG. 8 (taking the first resource interaction condition being the delivery starting condition as an example).

Further, the current user may continue to add a recommended object to the resource interaction object set. When the total resource value of the resource interaction objects reaches the first resource threshold of the first resource interaction condition but has not reached the second resource threshold of the second resource interaction condition, the quantity attribute information and the total resource value of the resource interaction objects may be presented, and the first difference value information is switched to the second difference value information, as shown in the third figure in FIG. 8 (in the drawing, the second resource interaction condition being a reduction condition is taken as an example).

Further, as the current user adds recommended objects to the resource interaction object set, when the total resource value of the resource interaction objects has reached the second resource threshold, the presentation of the prompt information may be canceled, or the promotional information of the first resource interaction condition and/or the promotional information of the second resource interaction condition may be presented, as shown in the fourth figure in FIG. 8 (in the drawing, the promotional information of the second resource interaction condition is presented as an example).

At S204, resource interaction is performed based on the resource interaction object in response to a resource interaction operation acting within the recommended object interface.

According to the method for resource interaction provided in this embodiment, the user is supported to add a resource interaction object to the resource interaction set, view a resource interaction object set, and/or perform resource interaction in batches on resource interaction objects selected in a current live streaming room in a live broadcast viewing process, so that functions of an object interface recommendation can be further enriched, different interaction requirements of the user are met, and resource interaction experience of the user is improved.

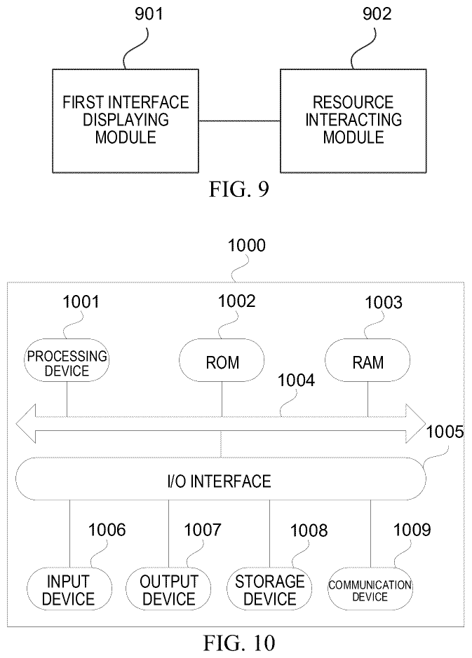

FIG. 9 is a structural block diagram illustrating an apparatus for resource interaction according to an embodiment of the present disclosure. The apparatus may be implemented by software and/or hardware, and may be configured in an electronic device, and typically, may be configured in a mobile phone or a tablet computer, and may perform resource interaction on recommended objects added to an object set by executing a method for resource interaction, for example, perform resource interaction on the recommended objects added to the object set in batches. As shown in FIG. 9, the apparatus for resource interaction provided in this embodiment may include: a first interface displaying module 901 and a resource interacting module 902.

The first interface display module 901 presents a recommended object interface in a live streaming interface of a current live streaming room, recommended object information of at least one recommended object in the current live streaming room and prompt information for a resource interaction object being presented within the recommended object interface, the resource interaction object being a recommended object added to a resource interaction object set, the resource interaction object set being a set of recommended objects selected by a current user in the current live streaming room, and the prompt information being configured to prompt object attribute information of the resource interaction object set.

The resource interacting module 902 is to perform resource interaction based on the resource interaction object in response to a resource interaction operation acting within the recommended object interface.

According to the apparatus for resource interaction provided in this embodiment, a recommended object interface is presented in a live streaming interface of a current live streaming room by using a first interface displaying module, recommended object information of at least one recommended object in the current live streaming room and prompt information for a resource interaction object are presented within the recommended object interface, the resource interaction object is a recommended object added to a resource interaction object set, the resource interaction object set is a set of recommended objects selected by a current user in the current live streaming room, and the prompt information is configured to prompt object attribute information of the resource interaction object set; and resource interaction is performed based on the resource interaction object in response to a resource interaction operation acting within the recommended object interface by using a resource interaction module. According to the embodiment of the present disclosure, by adopting the above technical solution, the user is supported to view; in the recommended object interface, the object attribute information of the resource interaction object added to the resource interaction object set, and perform, in the recommended object interface, resource interaction on the resource interaction object added to the resource interaction object set by performing the resource interaction operation, so that functions of the recommended object interface can be enriched, and operations required for the user to view the attribute information of the resource interaction object and obtaining the resource interaction object in a resource interaction manner are simplified.

In the foregoing solution, the resource interacting module 902 may be configured to: in response to the resource interaction operation acting within the recommended object interface, presenting an information confirmation interface in the live streaming interface, and presenting resource interaction information of the resource interaction object in the information confirmation interface; in response to an information confirmation operation acting within the information confirmation interface, displaying a resource interaction interface; and in response to an interaction confirmation operation acting within the resource interaction interface, performing the resource interaction based on a total resource value of the resource interaction objects.

Further, the apparatus for resource interaction provided in this embodiment may further include at least one of the following: a set presenting module, configured to, after presenting the recommended object interface in the live streaming interface of the current live streaming room and in response to a set presenting operation acting within the recommended object interface, presenting the resource interaction object set of the current user; and an object adding module, configured to, after presenting the recommended object interface in the live streaming interface of the current live streaming room and in response to an object adding operation acting within the recommended object interface, add a recommended object corresponding to the object adding operation to the resource interaction object set of the current user.

Further, the apparatus for resource interaction provided in this embodiment may further include: a content updating module, configured to update information content of the prompt information after the recommended object corresponding to the object adding operation is added to the resource interaction object set of the current user, where the information content includes the object attribute information, the object attribute information includes resource attribute information and/or quantity attribute information, the resource attribute information includes a total resource value of the resource interaction objects, and/or first difference information between a first resource threshold for a first resource interaction condition and the total resource value, or second difference information between a second resource threshold for a second resource interaction condition and the total resource value, wherein the first resource interaction condition is that the total resource value of the resource interaction objects is greater than or equal to the first resource threshold, the second resource interaction condition is that the total resource value of the resource interaction object is greater than or equal to the second resource threshold, and the second resource threshold is greater than the first resource threshold.

In the foregoing solution, the content updating module may be specifically configured to: in response to that no resource interaction object has been added to the resource interaction object set, present the quantity attribute information of the resource interaction object and the second resource interaction condition; in response to that a resource interaction object is added to the resource interaction object set and a total resource value of the resource interaction objects has not reached the first resource threshold, present the quantity attribute information and the total resource value of the resource interaction objects, and the first difference value information; in response to that the total resource value of the resource interaction object has reached the first resource threshold and has not reached the second resource threshold, present the quantity attribute information and the total resource value of the resource interaction objects, and switch the first difference value information to the second difference value information; and in response to that the total resource value of the resource interaction objects has reached the second resource threshold, cancel presentation of the prompt information, or present promotional information of the first resource interaction condition and/or promotional information of the second resource interaction condition.

In the foregoing solution, the recommended object information may include an image element of the recommended object, and the apparatus for resource interaction provided in this embodiment may further include: a movement controlling module, configured to control, in response to an object adding operation, controlling an image element of a recommended object corresponding to the object adding operation to move to a preset display position of the recommended object interface, the object adding operation acting within the recommended object interface or an object addition interface, at least one adding option for the recommended object corresponding to the object adding operation being presented in the object addition interface, and the preset display position is a display position for a set control of the resource interaction object set; and a presentation canceling module, configured to: in response to that the image element moves to the preset display position, cancel presentation of the image element, and additionally present the quantity attribute information of the resource interaction objects or updating the quantity attribute information of the resource interaction objects.

In the foregoing solution, the prompt information may be presented above the recommended object information; and/or when the total resource value of the resource interaction objects does not meet a first resource interaction condition or a second resource interaction condition, an object presentation control is further presented within a preset distance range of the prompt information, and the apparatus for resource interaction provided by the embodiments of the present disclosure further includes: a second interface presenting module, configured to, in response to a triggering operation on the object presentation control, present a target object interface in the live streaming interface, recommended object information of at least one target recommended object in the current live streaming room is presented in the target object interface, where the target recommended object is determined based on first difference information between a first resource threshold for the first resource interaction condition and the total resource value, or the target recommended object is determined based on second difference information between a second resource threshold for the second resource interaction condition and the total resource value.

In the foregoing solution, at least one of at least one resource value range, promotional information of the first resource interaction condition, and promotional information of the second resource interaction condition is further presented in the target object interface, and the resource value range is configured to trigger presentation of a target recommended object corresponding to a triggered resource value range in the target object interface.

The apparatus for resource interaction provided by the embodiment of the present disclosure may execute the method for resource interaction provided by any embodiment of the present disclosure, and has corresponding functional modules and beneficial effects for executing the method for resource interaction. For technical details not described in detail in this embodiment, please refer to the method for resource interaction provided in any embodiment of the present disclosure.

Referring to FIG. 10 below, it illustrates a schematic structural diagram of an electronic device (for example. a terminal device) 1000 suitable for implementing the embodiments of the present disclosure. The terminal device in the embodiments of the present disclosure may include, but is not limited to, a mobile terminal such as a mobile phone, a notebook computer, a digital broadcast receiver, a PDA (personal digital assistant), a PAD (tablet computer). a PMP (portable multimedia player), an in-vehicle terminal (for example, an in-vehicle navigation terminal), and a fixed terminal such as a digital TV or a desktop computer. The electronic device shown in FIG. 10 is merely an example, and should not bring any limitation to the function and scope of usage of the embodiments of the present disclosure.

As shown in FIG. 10, the electronic device 1000 may include a processing device (e.g., a central processing unit, a graphics processor, etc.) 1001, which may perform various appropriate actions and processing according to a program stored in a read-only memory (ROM) 1002 or a program loaded into a random-access memory (RAM) 1003 from a storage device 1008. In the RAM 1003, various programs and data required by operation of the electronic device 1000 are also stored. The processing device 1001, the ROM 1002, and the RAM 1003 are connected to each other through a bus 1004. An input/output (I/O) interface 1005 is also connected to the bus 1004.

Generally, the following devices can be connected to I/O interface 1005; an input device 1006 including, for example, a touch screen, a touchpad, a keyboard, mouse, a camera, a microphone, an accelerometer, a gyroscope. etc.; an output device 1007 including a liquid crystal display (LCD), a speaker, a vibrator, etc.; a storage device 1008 including a magnetic tape, a hard disk, etc.; and a communication device 1009. The communication device 1009 may allow the electronic device 1000 to communicate with other devices wirelessly or wirelessly to exchange data. Although FIG. 10 shows an electronic device 1000 with various devices, it shall be understood that it is not required to implement or have all the devices shown. More or fewer devices can be implemented or provided instead.

In particular, according to embodiments of the present disclosure, the process described above with reference to the flowchart can be implemented as a computer software program. For example, an embodiment of the present disclosure includes a computer program product that includes a computer program carried on a non-transitory computer-readable medium, where the computer program includes program code for performing the method shown in the flowchart. In such an embodiment, the computer program can be downloaded and installed from a network through the communication device 1009, or installed from the storage device 1008, or installed from the ROM 1002. When the computer program is executed by the processing device 1001, the above functions defined in the method for rendering a virtual image of the embodiment of the present disclosure are performed.

It should be noted that the computer-readable medium described above in the present disclosure may be a computer-readable signal medium or a computer-readable storage medium or any combination thereof. The computer-readable storage medium may be, for example, but not limited to, an electrical, magnetic, optical. electromagnetic, infrared, or semiconductor system, apparatus, or device, or any combination thereof. More specific examples of the computer-readable storage medium may include, but are not limited to, an electrical connection with one or more wires, a portable computer disk, a hard disk. Random Access Memory (RAM). Read-Only Memory (ROM), an Erasable Programmable Read-Only Memory (EPROM) or flash memory (FLASH), an optical fiber, a portable Compact Disk Read-Only Memory (CD-ROM), an optical storage device, a magnetic storage device, or any suitable combination thereof. In the present disclosure, a computer-readable storage medium may be any tangible medium containing or storing a program that can be used by an instruction execution system, apparatus, or device. or can be used in combination with an instruction execution system, apparatus, or device. In the present disclosure. a computer-readable signal medium can include a data signal propagated in baseband or as part of a carrier wave. which carries computer-readable program code therein. Such propagated data signals may take many forms. including, but not limited to, electromagnetic signals, optical signals, or any suitable combination thereof. A computer-readable signal medium may also be any computer-readable medium other than a computer-readable storage medium, which can send, propagate, or transmit programs for use by or in conjunction with instruction execution systems, apparatus, or devices. The program code contained on the computer-readable medium may be transmitted using any suitable medium, including, but not limited to: wires, optical cables, radio frequency (RF), etc., or any suitable combination thereof.

In some embodiments, clients and servers can communicate using any currently known or future developed network protocol such as Hypertext Transfer Protocol (HTTP), and can be interconnected with any form or medium of digital data communication (such as communication networks). Examples of communication networks include Local Area Networks (“LANs”), Wide Area Networks (“WANs”), internetworks (such as the Internet), and end-to-end networks (such as ad hoc end-to-end networks), as well as any currently known or future developed networks.

The computer-readable medium can be included in the electronic device, or it can exist alone without being assembled into the electronic device.

The above-mentioned computer-readable medium carries one or more programs, and when the above-mentioned one or more programs are executed by the electronic device, the electronic device: presenting a recommended object interface in a live streaming interface of a current live streaming room, recommended object information of at least one recommended object in the current live streaming room and prompt information for a resource interaction object being presented within the recommended object interface, the resource interaction object being a recommended object added to a resource interaction object set, the resource interaction object set being a set of recommended objects selected by a current user in the current live streaming room, and the prompt information being configured to prompt object attribute information of the resource interaction object set; and in response to a resource interaction operation acting within the recommended object interface, performing resource interaction based on the resource interaction object.

Computer program codes for performing the operations of the present disclosure may be written in one or more programming languages or a combination thereof, including, but not limited to. Object Oriented programming languages-such as Java. Smalltalk. C++, and conventional procedural programming languages—such as “C” or similar programming languages. The program code may be executed entirely on the user's computer, partially executed on the user's computer, executed as a standalone software package, partially executed on the user's computer and partially on a remote computer, or entirely on a remote computer or server. In the case of involving a remote computer, the remote computer may be any kind of network-including Local Area Network (LAN) or Wide Area Network (WAN)-connected to the user's computer, or may be connected to an external computer (e.g., through an Internet service provider to connect via the Internet).

The flowcharts and block diagrams in the accompanying drawings illustrate the architecture, functions, and operations of possible implementations of the system, method, and computer program product according to various embodiments of the present disclosure. In this regard, each block in a flowchart or block diagram may represent a module, program segment, or portion of code that contains one or more executable instructions for implementing a specified logical function. It should also be noted that in some alternative implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

The units described in the embodiments of the present disclosure may be implemented by means of software or hardware. The name of the module does not constitute a limitation on the unit itself in a certain case.

The functions described herein above can be performed at least in part by one or more hardware logic components. For example, exemplary types of hardware logic components that may be used include: Field Programmable Gate Arrays (FPGAs), Application Specific Integrated Circuits (ASICs), Application Specific Standard Parts (ASSPs), System on Chip (SOCs), Complex Programmable Logic Devices (CPLDs), and so on.

In the context of this disclosure, a machine-readable medium can be a tangible medium that may contain or store programs for use by or in conjunction with instruction execution systems, apparatuses, or devices. A machine-readable medium may be a machine-readable signal medium or a machine-readable storage medium. A machine-readable medium may include, but are not limited to, electronic, magnetic, optical, electromagnetic, infrared, or semiconductor systems, apparatuses, or devices, or any suitable combination thereof. Specific examples of the machine-readable storage medium may include electrical connections based on one or more wires, portable computer disks, hard disks, Random Access Memory (RAM), Read-Only Memory (ROM), an Erasable Programmable Read-Only Memory (EPROM) or flash memory (FLASH), an optical fiber, a portable Compact Disk Read-Only Memory (CD-ROM), optical storage devices, magnetic storage devices, or any suitable combination thereof.

The above description is only embodiments of this disclosure and an explanation of the technical principles used. Those skilled in the art should understand that the scope of the disclosure involved in this disclosure is not limited to technical solutions composed of specific combinations of the above technical features, but should also covers other technical solutions formed by arbitrary combinations of the above technical features or their equivalent features without departing from the above disclosure concept. For example, technical solutions formed by replacing the above features with (but not limited to) technical features with similar functions disclosed in this disclosure.

In addition, although a plurality of operations are depicted in a specific order, this should not be understood as requiring these operations to be performed in the specific order shown or in a sequential order. In certain environments, multitasking and parallel processing may be advantageous. Similarly, although a plurality of implementation details are included in the above discussion, these should not be construed as limiting the scope of the present disclosure. Some features described in the context of individual embodiments can also be implemented in combination in a single embodiment. Conversely, a plurality of features described in the context of a single embodiment can also be implemented in a plurality of embodiments separately or in any suitable sub-combination.

Although the subject matter has been described in language specific to structural features and/or methodological logical actions, it shall be understood that the subject matter defined in the appended claims is not necessarily limited to the specific features or actions described above. On the contrary, the specific features and actions described above are merely example forms of implementing the claims.

I/we claim:

1. A method for resource interaction, comprising:
presenting a recommended object interface in a live streaming interface of a current live streaming room, recommended object information of at least one recommended object in the current live streaming room and prompt information for a resource interaction object being presented within the recommended object interface, the resource interaction object being a recommended object added to a resource interaction object set, the resource interaction object set being a set of recommended objects selected by a current user in the current live streaming room, and the prompt information being configured to prompt object attribute information of the resource interaction object set; and
in response to a resource interaction operation acting within the recommended object interface, performing resource interaction based on the resource interaction object.

2. The method of claim 1, wherein performing the resource interaction based on the resource interaction object in response to the resource interaction operation acting within the recommended object interface comprises:
in response to the resource interaction operation acting within the recommended object interface, presenting an information confirmation interface in the live streaming interface, and presenting resource interaction information of the resource interaction object in the information confirmation interface;
in response to an information confirmation operation acting within the information confirmation interface, displaying a resource interaction interface; and
in response to an interaction confirmation operation acting within the resource interaction interface, performing the resource interaction based on a total resource value of the resource interaction objects.

3. The method of claim 1, further comprising at least one of the following: after presenting the recommended object interface in the live streaming interface of the current live streaming room,
in response to a set presenting operation acting within the recommended object interface, presenting the resource interaction object set of the current user; and
in response to an object adding operation acting within the recommended object interface, adding a recommended object corresponding to the object adding operation to the resource interaction object set of the current user.

4. The method of claim 3, further comprising: after adding the recommended object corresponding to the object adding operation to the resource interaction object set of the current user,
updating information content of the prompt information, the information content comprising the object attribute information, and the object attribute information comprising resource attribute information and/or quantity attribute information; and the resource attribute information comprising a total resource value of the resource interaction objects, and/or first difference information between a first resource threshold for a first resource interaction condition and the total resource value, or second difference information between a second resource threshold for a second resource interaction condition and the total resource value, wherein the first resource interaction condition is that the total resource value of the resource interaction objects is greater than or equal to the first resource threshold, the second resource interaction condition is that the total resource value of the resource interaction objects is greater than or equal to the second resource threshold, and the second resource threshold is greater than the first resource threshold.

5. The method of claim 4, wherein updating the information content of the prompt information comprises:
in response to that no resource interaction object has been added to the resource interaction object set, presenting the quantity attribute information of the resource interaction objects and the second resource interaction condition;
in response to that a resource interaction object is added to the resource interaction object set and a total resource value of the resource interaction objects has not reached the first resource threshold, presenting the quantity attribute information and the total resource value of the resource interaction objects, and the first difference value information;
in response to that the total resource value of the resource interaction objects has reached the first resource threshold and has not reached the second resource threshold, presenting the quantity attribute information and the total resource value of the resource interaction objects, and switching the first difference value information to the second difference value information; and
in response to that the total resource value of the resource interaction objects has reached the second resource threshold, canceling presentation of the prompt information, or presenting promotional information of the first resource interaction condition and/or promotional information of the second resource interaction condition.

6. The method of claim 3, wherein the recommended object information comprises an image element of the recommended object, and the method further comprises:
in response to an object adding operation, controlling an image element of a recommended object corresponding to the object adding operation to move to a preset display position of the recommended object interface, the object adding operation acting within the recommended object interface or an object addition interface, at least one adding option for the recommended object corresponding to the object adding operation being presented in the object addition interface, and the preset display position being a display position for a set control of the resource interaction object set;
in response to that the image element moves to the preset display position, canceling presentation of the image element, and additionally presenting the quantity attribute information of the resource interaction objects or updating the quantity attribute information of the resource interaction objects.

7. The method of claim 1, wherein the prompt information is presented above the recommended object information; and/or
in response to that the total resource value of the resource interaction objects does not meet a first resource interaction condition or a second resource interaction condition, an object presentation control is further presented within a preset distance range of the prompt information, and the method further comprises:
in response to a triggering operation on the object presentation control, presenting a target object interface in the live streaming interface, recommended object information of at least one target recommended object in the current live streaming room is presented in the target object interface, wherein the target recommended object is determined based on first difference information between a first resource threshold for the first resource interaction condition and the total resource value, or the target recommended object is determined based on second difference information between a second resource threshold for the second resource interaction condition and the total resource value.

8. The method of claim 7, wherein at least one of at least one resource value range, promotional information of the first resource interaction condition, and promotional information of the second resource interaction condition is further presented in the target object interface, and the resource value range is configured to trigger presentation of a target recommended object corresponding to a triggered resource value range in the target object interface.

9. An electronic device, comprising:
at least one processor; and
a memory communicatively connected to the at least one processor, wherein the memory stores a computer program executable by the at least one processor, and when executed by the at least one processor, the computer program causes the at least one processor to implement acts comprising:
presenting a recommended object interface in a live streaming interface of a current live streaming room, recommended object information of at least one recommended object in the current live streaming room and prompt information for a resource interaction object being presented within the recommended object interface, the resource interaction object being a recommended object added to a resource interaction object set, the resource interaction object set being a set of recommended objects selected by a current user in the current live streaming room, and the prompt information being configured to prompt object attribute information of the resource interaction object set; and
in response to a resource interaction operation acting within the recommended object interface, performing resource interaction based on the resource interaction object.

10. The electronic device of claim 9, wherein performing the resource interaction based on the resource interaction object in response to the resource interaction operation acting within the recommended object interface comprises:
in response to the resource interaction operation acting within the recommended object interface, presenting an information confirmation interface in the live streaming interface, and presenting resource interaction information of the resource interaction object in the information confirmation interface;
in response to an information confirmation operation acting within the information confirmation interface, displaying a resource interaction interface; and
in response to an interaction confirmation operation acting within the resource interaction interface, performing the resource interaction based on a total resource value of the resource interaction objects.

11. The electronic device of claim 9, wherein the acts further comprise at least one of the following: after presenting the recommended object interface in the live streaming interface of the current live streaming room,
in response to a set presenting operation acting within the recommended object interface, presenting the resource interaction object set of the current user; and
in response to an object adding operation acting within the recommended object interface, adding a recommended object corresponding to the object adding operation to the resource interaction object set of the current user.

12. The electronic device of claim 11, wherein the acts further comprise: after adding the recommended object corresponding to the object adding operation to the resource interaction object set of the current user,
updating information content of the prompt information, the information content comprising the object attribute information, and the object attribute information comprising resource attribute information and/or quantity attribute information; and the resource attribute information comprising a total resource value of the resource interaction objects, and/or first difference information between a first resource threshold for a first resource interaction condition and the total resource value, or second difference information between a second resource threshold for a second resource interaction condition and the total resource value, wherein the first resource interaction condition is that the total resource value of the resource interaction objects is greater than or equal to the first resource threshold, the second resource interaction condition is that the total resource value of the resource interaction objects is greater than or equal to the second resource threshold, and the second resource threshold is greater than the first resource threshold.

13. The electronic device of claim 12, wherein updating the information content of the prompt information comprises:
in response to that no resource interaction object has been added to the resource interaction object set. presenting the quantity attribute information of the resource interaction objects and the second resource interaction condition;
in response to that a resource interaction object is added to the resource interaction object set and a total resource value of the resource interaction objects has not reached the first resource threshold, presenting the quantity attribute information and the total resource value of the resource interaction objects, and the first difference value information;
in response to that the total resource value of the resource interaction objects has reached the first resource threshold and has not reached the second resource threshold, presenting the quantity attribute information and the total resource value of the resource interaction objects, and switching the first difference value information to the second difference value information; and
in response to that the total resource value of the resource interaction objects has reached the second resource threshold, canceling presentation of the prompt information, or presenting promotional information of the first resource interaction condition and/or promotional information of the second resource interaction condition.

14. The electronic device of claim 11, wherein the recommended object information comprises an image element of the recommended object, and the method further comprises:
in response to an object adding operation, controlling an image element of a recommended object corresponding to the object adding operation to move to a preset display position of the recommended object interface, the object adding operation acting within the recommended object interface or an object addition interface, at least one adding option for the recommended object corresponding to the object adding operation being presented in the object addition interface, and the preset display position being a display position for a set control of the resource interaction object set;
in response to that the image element moves to the preset display position, canceling presentation of the image element, and additionally presenting the quantity attribute information of the resource interaction objects or updating the quantity attribute information of the resource interaction objects.

15. The electronic device of claim 9, wherein the prompt information is presented above the recommended object information; and/or
in response to that the total resource value of the resource interaction objects does not meet a first resource interaction condition or a second resource interaction condition, an object presentation control is further presented within a preset distance range of the prompt information, and the method further comprises:
in response to a triggering operation on the object presentation control, presenting a target object interface in the live streaming interface, recommended object information of at least one target recommended object in the current live streaming room is presented in the target object interface, wherein the target recommended object is determined based on first difference information between a first resource threshold for the first resource interaction condition and the total resource value, or the target recommended object is determined based on second difference information between a second resource threshold for the second resource interaction condition and the total resource value.

16. The electronic device of claim 15, wherein at least one of at least one resource value range, promotional information of the first resource interaction condition, and promotional information of the second resource interaction condition is further presented in the target object interface, and the resource value range is configured to trigger presentation of a target recommended object corresponding to a triggered resource value range in the target object interface.

17. A non-transitory computer-readable storage medium, wherein the computer-readable storage medium stores computer instructions, and the computer instructions are configured to, when executed by a process, implement acts comprising:
presenting a recommended object interface in a live streaming interface of a current live streaming room, recommended object information of at least one recommended object in the current live streaming room and prompt information for a resource interaction object being presented within the recommended object interface, the resource interaction object being a recommended object added to a resource interaction object set, the resource interaction object set being a set of recommended objects selected by a current user in the current live streaming room, and the prompt information being configured to prompt object attribute information of the resource interaction object set; and
in response to a resource interaction operation acting within the recommended object interface, performing resource interaction based on the resource interaction object.

18. The non-transitory computer-readable storage medium of claim 17, wherein performing the resource interaction based on the resource interaction object in response to the resource interaction operation acting within the recommended object interface comprises:
in response to the resource interaction operation acting within the recommended object interface, presenting an information confirmation interface in the live streaming interface, and presenting resource interaction information of the resource interaction object in the information confirmation interface;
in response to an information confirmation operation acting within the information confirmation interface, displaying a resource interaction interface; and in response to an interaction confirmation operation acting within the resource interaction interface, performing the resource interaction based on a total resource value of the resource interaction objects.

19. The non-transitory computer-readable storage medium of claim 17, wherein the acts further comprise at least one of the following: after presenting the recommended object interface in the live streaming interface of the current live streaming room,
in response to a set presenting operation acting within the recommended object interface, presenting the resource interaction object set of the current user; and
in response to an object adding operation acting within the recommended object interface, adding a recommended object corresponding to the object adding operation to the resource interaction object set of the current user.

20. The non-transitory computer-readable storage medium of claim 19, wherein the acts further comprise: after adding the recommended object corresponding to the object adding operation to the resource interaction object set of the current user,
updating information content of the prompt information, the information content comprising the object attribute information, and the object attribute information comprising resource attribute information and/or quantity attribute information; and the resource attribute information comprising a total resource value of the resource interaction objects, and/or first difference information between a first resource threshold for a first resource interaction condition and the total resource value, or second difference information between a second resource threshold for a second resource interaction condition and the total resource value, wherein the first resource interaction condition is that the total resource value of the resource interaction objects is greater than or equal to the first resource threshold, the second resource interaction condition is that the total resource value of the resource interaction objects is greater than or equal to the second resource threshold, and the second resource threshold is greater than the first resource threshold.
